(19) United States
(12) Patent Application Publication
(10) Pub. No.: US 2026/0022254 A1
(43) Pub. Date: Jan. 22, 2026

(54) COATING SYSTEMS FOR COMPOSITE PROTECTION

(71) Applicant: The Boeing Company, Arlington, VA (US)

(72) Inventors: Karen Ann Schultz, Seattle, WA (US); Jill Elisabeth Seebergh, Seattle, WA (US); Nels Andrew Olson, Seattle, WA (US); Paul Griffin Vahey, Seattle, WA (US); Ekaterina A. Badaeva, Bellevue, WA (US); Marcos Pantoja, St. Louis, MO (US); Geoffrey Michael House, Maple Valley, WA (US); Dara Ung, Lake Forest Park, WA (US)

(21) Appl. No.: 18/777,183

(22) Filed: Jul. 18, 2024

(51) Int. Cl. C09D 5/33; B64C 1/00; C09D 5/32; C09D 7/41; C09D 7/61; C09D 163/00; C09D 175/04

(52) U.S. Cl. CPC C09D 5/004; B64C 1/00; C09D 5/32; C09D 7/41; C09D 7/61; C09D 163/00; C09D 175/04; B64C 2001/0072

(57) ABSTRACT

A coating system for a composite component is presented. The coating system comprises a first layer comprising a chemical blocker configured to prevent transmission of at least one of ultraviolet light or visible light within desired wavelengths, and a second layer thereover and in contact with the first layer and configured to reflect infrared components of sunlight. The second layer comprises a colorant configured to reflect the infrared components of sunlight, wherein the first layer is positioned between the second layer and the composite component.

### BACKGROUND INFORMATION

### 1. Field

The present disclosure relates generally to coatings and more specifically to coating systems for composite materials.

### 2. Background

Fiber-reinforced composite materials can be used for platforms including buildings or large vehicles such as aircraft, ships, cars, trains, and other modes of transportation. Operating environments for vehicles comprising fiber-reinforced composite materials can cause degradation of the fiber-reinforced composite materials if the fiber-reinforced composite materials are exposed to the operating environment.

Therefore, it would be desirable to have a method and apparatus that takes into account at least some of the issues discussed above, as well as other possible issues. Specifically, it would be desirable to provide coating systems for protection of fiber-reinforced composite materials from operating conditions.

### SUMMARY

An embodiment of the present disclosure provides a coating system for a composite component. The coating system comprises a first layer and a second layer thereover and in contact with the first layer. The first layer comprises a chemical blocker configured to prevent transmission of at least one of ultraviolet light or visible light within desired wavelengths. The second layer is configured to reflect infrared components of sunlight. The second layer comprises a colorant configured to reflect the infrared components of sunlight, wherein the first layer is positioned between the second layer and the composite component.

Another embodiment of the present disclosure provides an aircraft. The aircraft comprises a composite component and a coating system on the composite component. The coating system comprises a first layer comprising a chemical blocker configured to prevent transmission of at least one of ultraviolet light or visible light within desired wavelengths, and a second layer configured to reflect infrared components of sunlight. The second layer comprises a colorant configured to reflect the infrared components of sunlight, wherein the first layer is positioned between the second layer and the composite component.

Another embodiment of the present disclosure provides a coating system for a composite component. The coating system comprises a first layer configured to prevent transmission of at least one of ultraviolet light or visible light within desired wavelengths and comprising a chemical blocker comprising at least one of a benzotriazole, a triazine, or a benzophenone, and a second layer configured to provide a desired solar absorptivity and comprising between 16 wt %-41 wt& titanium dioxide. The second layer is in contact with the first layer, wherein the first layer is positioned between the second layer and the composite component.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a platform with a coating system in an operating environment in accordance with an illustrative embodiment;

FIG. 3 is an illustration of a cross-sectional view of a coating system on a composite material in accordance with an illustrative embodiment;

FIG. 4 is an illustration of an aircraft manufacturing and service method in the form of a block diagram in accordance with an illustrative embodiment;

and;

FIG. 5 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that components made of fiber-reinforced composite materials can be susceptible to degradation upon exposure to combinations of electromagnetic radiation, moisture, and heat. The illustrative embodiments recognize and take into account that it is desirable to protect fiber-reinforced composite materials from components of sunlight.

The illustrative embodiments recognize and take into account that it is desirable to protect fiber-reinforced composite materials without undesirably impacting other material characteristics or operating standards for a respective platform. The illustrative examples recognize and take into account that aircraft have several operating standards set by regulatory agencies. Additionally, the illustrative examples recognize and take into account that it is undesirable to increase weight of aircraft. The illustrative embodiments recognize and take into account that substantially increasing the thickness of coatings can increase the risk of cracking, will add weight, and may not meet Electromagnetic Effects (EME) standards for aircraft.

Described herein are coatings having the ability to block UV-visible light penetration at the composite surface (interior) while meeting requirements for visible color and solar absorptivity (exterior) without excessively thick layers of paint, thereby avoiding issues such as cracking, weight, EME and the like.

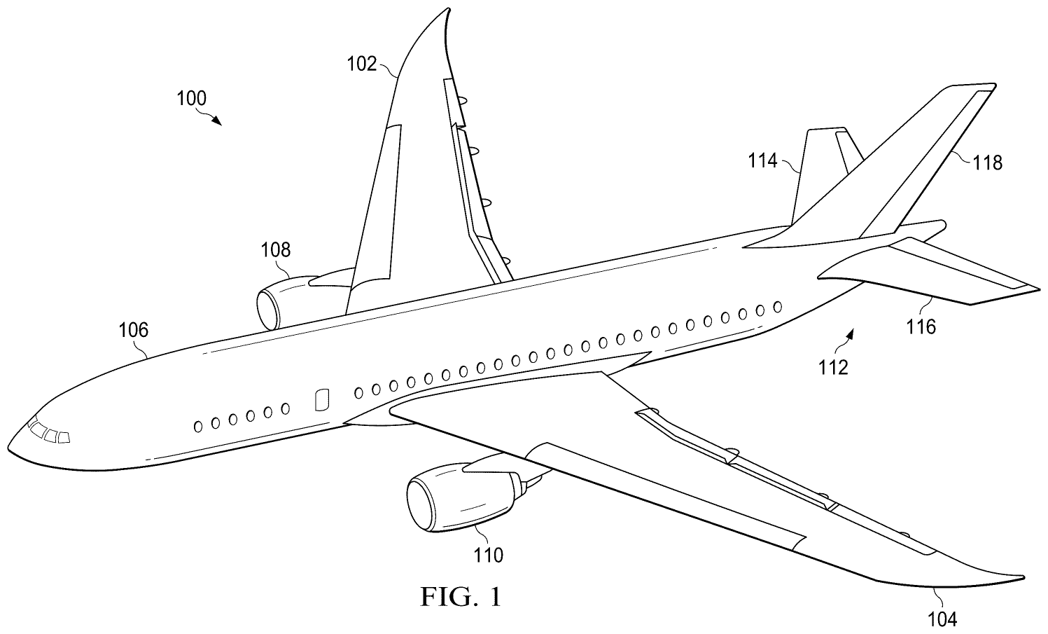

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have coatings configured to protect composite materials from ultraviolet light or visible light degradation. Coatings of the illustrative examples can be present on at least one of wing 102, wing 104, body 106, or tail section 112.

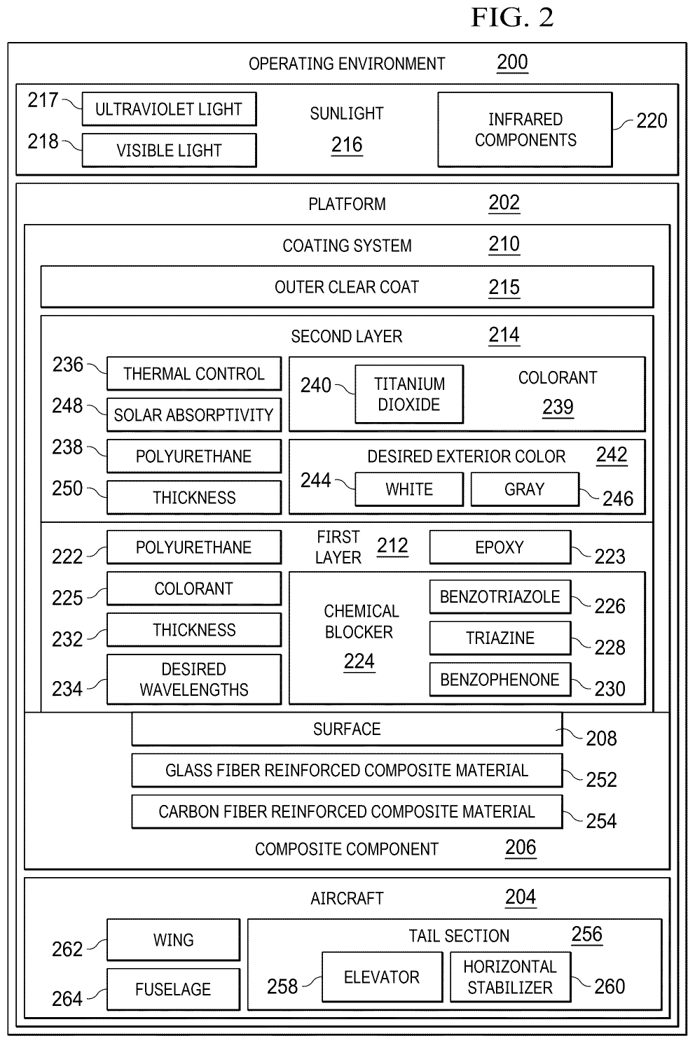

Turning now to FIG. 2, an illustration of a block diagram of an operating environment is depicted in accordance with an illustrative embodiment. Platform 202 is present in operating environment 200 and exposed to sunlight 216. Platform 202 can take any desirable form.

Coating system 210 provides protection for composite component 206 of platform 202. Coating system 210 protects composite component 206 from sunlight 216. Coating system 210 comprises first layer 212 comprising chemical blocker 224 configured to prevent transmission of at least one of ultraviolet light 217 or visible light 218 within desired wavelengths 234 and second layer 214 in contact with first layer 212 and configured to reflect infrared components 220 of sunlight 216. First layer 212 can be applied over composite component 206 as one of a coating, a film, or an ink.

Second layer 214 is exposed to operating environment 200. As a result, sunlight 216 strikes second layer 214. Second layer 214 is positioned on top of first layer 212 and covers first layer 212.

Second layer 214 comprises colorant 239 configured to reflect infrared components 220 of sunlight 216. Colorant 239 comprises any desirable colorant configured to reflect infrared components 220 of sunlight 216. In some illustrative examples, colorant 239 comprises titanium dioxide 240. Colorant 239 can be present in any desirable polymeric material in second layer 214. In some illustrative examples, second layer 214 comprises at least one of an epoxy, acrylic, polyurethane 238, polyamide, modified rosin, hydrocarbon resin, or a modified cellulosic. In some illustrative examples, second layer 214 comprises polyurethane 238. First layer 212 is positioned between second layer 214 and composite component 206. Second layer 214 can be applied over composite component 206 as one of a coating, a film, or an ink.

A coating can be, for example, a thin layer or covering that may be, for example, liquid, fluid, continuous, or a material that flows freely and is of constant volume. Examples of coatings for this description include paints, primers, topcoats, and the like, and combinations thereof.

A film can be, for example, a thin material covering that may be in a solid or semi-solid state, and in some embodiments, may be flexible. Examples of films for this description include decals, stickers, wraps and the like.

An ink is a colored liquid or fluid used for writing, drawing, printing and the like. Examples include solid, liquid, hybrid and the like inks, and combinations thereof.

Composite component 206 comprises a fiber-reinforced matrix material. In some illustrative examples, fiber-reinforced materials comprise at least one of carbon fibers, boron fibers, glass fibers, polyester fibers, aramid fibers (such as, for example, Kevlar®), polymer fibers, or other desirable reinforcing fibers. In some illustrative examples, composite component 206 comprises at least one of polyester, vinyl ester, cyanate ester, bismaleimide, polyetherimide, polyphenylene sulphide, polyaryletherketone (including PEEK and PEKK), thermoset materials such as epoxy materials, or nylon. In some illustrative examples, an epoxy composite material comprises at least one of a novolac epoxy, an aromatic epoxy, an aliphatic epoxy, or a cyclic epoxy. In some illustrative examples, composite component 206 comprises a thermoset resin.

Currently, epoxy resin systems may incorporate multi-functional epoxy systems with di-functional epoxy systems to achieve a polymeric matrix with both improved tensile strength and compression-after-impact (CAI). The di-functional epoxy resin may be saturated, unsaturated, cycloaliphatic, aromatic, alicyclic, or heterocyclic. Examples of the di-functional epoxy resins may be those based on diglycidyl ether or Bisphenol F, Bisphenol A, phenol, and cresol epoxy novolacs, glycidyl ethers of phenol-aldehyde adducts, glycidyl ethers of aliphatic diols, diglycidyl ether, diethylene glycol diglycidyl ether, aromatic epoxy resins, aliphatic polyglycidyl ethers, epoxidised olefins, aromatic glycidyl amines, heterocyclic glycidyl imidines and amides, glycidyl ethers, or any combination thereof. The preferable di-functional epoxy resin may be from diglycidyl ether of Bisphenol F, diglycidyl ether of Bisphenol A, diglycidyl dihydroxy naphthalene, or any combination thereof.

In some illustrative examples, composite component 206 comprises one of a thermoset resin, an epoxy resin or a thermoplastic resin. In some illustrative examples, composite component 206 comprises carbon fiber-reinforced composite material 254. In some illustrative examples, composite component 206 comprises a glass fiber-reinforced composite material 252.

Composite component 206 can be formed using any desirable method. In some illustrative examples, composite component 206 can be formed through resin infusion, wet layup, or resin sweep.

Surface 208 is an exterior surface of composite component 206. In some illustrative examples, first layer 212 is in contact with surface 208 of composite component 206. In some illustrative examples, a surfacing film or primer is present between surface 208 and first layer 212.

In some illustrative examples, second layer 214 is an exterior surface of platform 202. In some illustrative examples, second layer 214 has desired exterior color 242 for performance. In some illustrative examples, second layer 214 is white 244 or gray 246. In some illustrative examples, second layer 214 provides thermal control 236 for coating system 210 through controlled solar absorptivity 248. Solar absorptivity 248 can be assessed using any desirable standard set forth by a materials or regulatory society such as the American Society for Testing and Materials. In some illustrative examples, solar absorptivity 248 can be assessed using ASTM E903-20.

In some illustrative examples, second layer 214 provides solar absorptivity 248 in a range of 0.20-0.67. In some illustrative examples, second layer 214 provides solar absorptivity 248 in a range of 0.20 to 0.67, or 0.23 to 0.67, or 0.23 to 0.53. In some illustrative examples, second layer 214 provides solar absorptivity 248 in a range of 0.21-0.23. In some illustrative examples, second layer 214 provides solar absorptivity 248 in a range of 0.58-0.67.

First layer 212 comprises chemical blocker 224. In some illustrative examples, first layer 212 further comprises at least one of polyurethane 222 or epoxy 223 with chemical blocker 224. In some illustrative examples, chemical blocker 224 is present in first layer 212 with at least one of epoxy 223, acrylic, polyurethane 222, polyamide, modified rosin, hydrocarbon resin, or a modified cellulosic. In some illustrative examples, chemical blocker 224 comprises at least one of a benzotriazole, a triazine, or a benzophenone. In some illustrative examples, the amount and specific types of chemical blocker 224 are configured to block transmission of at least one of ultraviolet light 217 or visible light 218 in desired wavelengths 234. Chemical blocker 224 is present in first layer 212 in any desirable weight range to prevent transmission of at least one of ultraviolet light 217 or visible light 218. The weight percentages presented herein are calculated as dry weight percentages.

In some illustrative examples, first layer 212 blocks transmission of at least one of ultraviolet light 217 or visible light 218 through absorption. In some illustrative examples, desired wavelengths 234 are in a range of 300-550 nm. In some illustrative examples, desired wavelengths 234 are in a range of 300-500 nm. In some illustrative examples, desired wavelengths 234 are in a range of 300-800 nm.

In some illustrative examples, first layer 212 comprises colorant 225. In some illustrative examples, first layer 212 further comprises colorant 225 having a light color. In some illustrative examples, second layer 214 is a lighter color than that of the first layer, such as white, and has the property of low solar absorptivity. In some illustrative examples, second layer 214 comprises a white colorant such as titanium dioxide 240 (aka, titania or TiO) in the rutile or anatase form, antimony white, zinc white, silicon dioxide, or the like in a range of 16 wt %-41 wts. In some illustrative examples, second layer 214 comprises titanium dioxide 240 in a range of 20-41 wt %. In some illustrative examples, second layer 214 comprises titanium dioxide 240 in a range of 16 wt %-21 wt %.

In some illustrative examples, coating system 210 for composite component 206 comprises first layer 212 configured to prevent transmission of at least one of ultraviolet light 217 or visible light 218 within desired wavelengths 234 and comprising chemical blockers 224 comprising at least one of benzotriazole 226, triazine 228, or benzophenone 230, and second layer 214 configured to provide desired solar absorptivity 248 and comprising between 16 wt %-41 wt % titanium dioxide 240, the second layer in contact with the first layer, wherein the first layer is positioned between the second layer and the composite component.

Thickness 232 of first layer 212 is selected to provide a desired amount of blocking of at least one of ultraviolet light 217 or visible light 218. Thickness 232 of first layer 212 is selected to provide desired material properties for coating system 210. In some illustrative examples, thickness 232 is selected based on at least one of a desired weight, a desired EME performance, and desired flexibility performance of coating system 210.

A thickness can be measured using any desirable standard set forth by a materials or regulatory society such as the American Society for Testing and Materials. In some illustrative examples, thickness 232 and thickness 250 can be assessed using ASTM D4138-22.

In some illustrative examples, first layer 212 comprises thickness 232 between 0.3-2.4 mils. In some illustrative examples, first layer 212 comprises thickness 232 between 0.3-0.8 mils. In some illustrative examples, first layer 212 comprises thickness 232 between 0.6-1.6 mils. In some illustrative examples, first layer 212 comprises thickness 232 between 1.4-2.4 mils. In some illustrative examples, first layer 212 comprises thickness 232 between 1.0-2.0 mils.

In some illustrative examples, thickness 232 is selected based on a location for coating system 210 on platform 202. In some illustrative examples, thickness 232 can be selected depending upon operating environment 200.

Thickness 250 and specific colorant 239 of second layer 214 are selected to provide reflection of infrared components 220 of sunlight 216. Thickness 250 of second layer 214 is selected to provide desired material properties for coating system 210. In some illustrative examples, thickness 250 is selected based on at least one of a desired weight, a desired EME performance, and desired flexibility performance of coating system 210.

In some illustrative examples, second layer 214 comprises thickness 250 between 2.0-4.0 mils. In some illustrative examples, second layer 214 comprises thickness 250 between 2.4-4.0 mils. In some illustrative examples, second layer 214 comprises thickness 250 between 2.4-3.2 mils. In some illustrative examples, second layer 214 comprises thickness 250 between 2.0-3.6 mils.

In some illustrative examples, platform 202 takes the form of aircraft 204. In these illustrative examples, aircraft 204 comprises composite component 206 and coating system 210 on composite component 206. Coating system 210 comprises first layer 212 comprising chemical blockers 224 configured to prevent transmission of at least one of ultraviolet light 217 or visible light 218 within desired wavelengths 234 and second layer 214 configured to reflect infrared components 220 of sunlight 216. Second layer 214 comprises colorant 239 configured to reflect infrared components 220 of sunlight 216. First layer 212 is positioned between second layer 214 and composite component 206.

Composite component 206 can take the form of any desirable component or portion of a component of platform 202. In some illustrative examples, composite component 206 is part of tail section 256 of aircraft 204. In some illustrative examples, composite component 206 is horizontal stabilizer 260. In some illustrative examples, horizontal stabilizer 260 can take the form of horizontal stabilizer 116 of FIG. 1. In some illustrative examples, composite component 206 is elevator 258 in tail section 256 of aircraft 204. In some illustrative examples, composite component 206 is wing 262 of aircraft 204. In some illustrative examples, composite component 206 is fuselage 264 of aircraft 204. In some illustrative examples, composite component 206 is one of fuselage 264, wing 262, or a portion of tail section 256 of aircraft 204.

In some illustrative examples, outer clear coat 215 is present in coating system 210. Outer clear coat 215 is in contact with second layer 214. Outer clear coat 215 is an optional layer that is not present in some illustrative examples. Outer clear coat 215 can provide additional protection to second layer 214 and first layer 212 from undesirable wear.

Coating system 210 of FIG. 2 can be applied by at least one of spraying, inkjet printing, wiping, rolling, or any other desirable application method. First layer 212 and second layer 214 can be applied in a liquid form to composite component 206. In some illustrative examples, first layer 212 can be applied and cured prior to applying second layer 214. In some illustrative examples, first layer 212 can be co-cured with composite component 206.

The illustration of operating environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, a surfacing film or primer could be present between surface 208 and first layer 212.

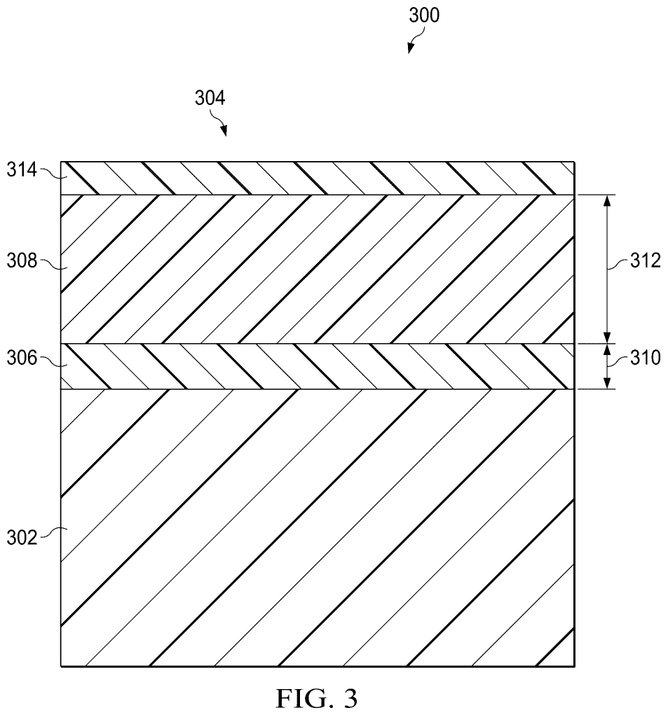

Turning now to FIG. 3, an illustration of a cross-sectional view of a coating system on a composite material is depicted in accordance with an illustrative embodiment. Composite component 302 is a physical implementation of composite component 206 of FIG. 2. Coating system 304 is present over composite component 302. Coating system 304 protects composite component 302 from degradation due to sunlight exposure. Coating system 304 is a physical implementation of coating system 210 of FIG. 2. View 300 is a cross-sectional view of coating system 304 on composite component 302.

Coating system 304 comprises first layer 306 and second layer 308. In this illustrative example, first layer 306 is in contact with composite component 302. In some non-depicted examples, a surfacing film or primer can be present between composite component 302 and first layer 306.

First layer 306 protects composite component 302 from at least one of ultraviolet light or visible light within desired wavelengths. First layer 306 comprises a chemical blocker. The chemical blocker is configured to prevent transmission of at least one of ultraviolet light or visible light within the desired wavelengths. In some illustrative examples, the chemical blocker comprises at least one of a benzotriazole, a triazine, or a benzophenone.

First layer 306 prevents or significantly reduces transmission of at least one of ultraviolet light or visible light within the desired wavelengths. First layer 306 at least one of absorbs or reflects at least one of ultraviolet light or visible light within the desired wavelengths. First layer 306 provides desirable blocking properties to the desired wavelengths. In some illustrative examples, first layer 306 provides protection to composite component 302 through absorption.

Second layer 308 is in contact with first layer 306. Second layer 308 provides thermal protection for composite component 302 while first layer 306 provides protection against at least one of ultraviolet light or visible light. In some illustrative examples, second layer 308 provides protection against infrared components of sunlight using solar absorptivity.

In some illustrative examples, first layer 306 is darker in color than second layer 308. In some illustrative examples, second layer 308 is white. In some other illustrative examples, second layer 308 is gray. In some illustrative examples, second layer 308 has desired exterior color for performance that can be selected from white, gray, beige, off-white, or any other desirable color.

Composite component 302 with coating system 304 is resistant to degradation from cyclic exposure to at least one of ultraviolet light or visible light and moisture. Composite component 302 with coating system 304 meets desired standards for solar absorptivity, color, and crack resistance. First layer 306 and second layer 308 are arranged in a specific order and have thickness 310 and thickness 312 configured to at least one of selectively absorb or reflect specific wavelengths of solar radiation while meeting the other desired coating characteristics. In some illustrative examples, coating system 304 meets a desired standard for corrosion resistance.

In this illustrative example, outer clear coat 314 is present in coating system 304. Outer clear coat 314 is in contact with second layer 308. Outer clear coat 314 is optional in some illustrative examples. Outer clear coat 314 can provide additional protection to second layer 308 and first layer 306 from undesirable wear.

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional.

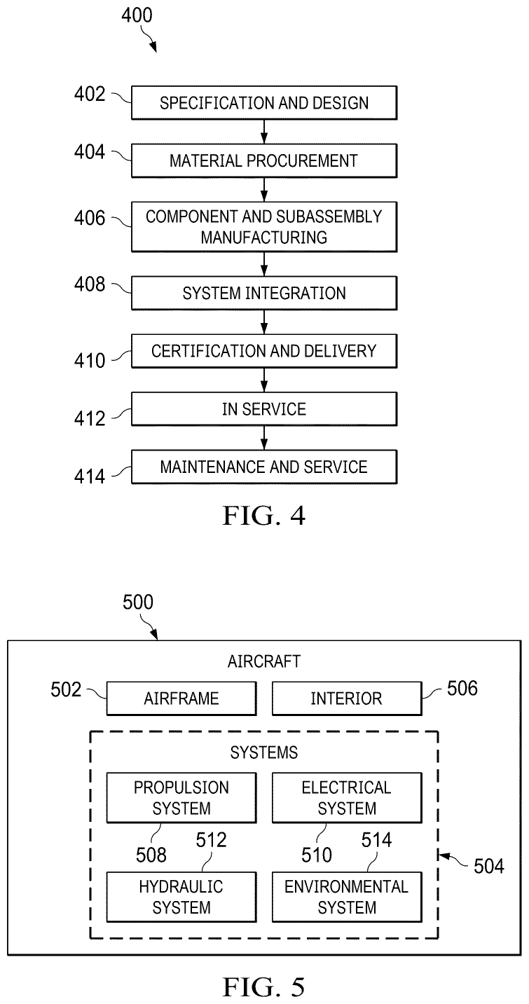

Illustrative embodiments of the present disclosure may be described in the context of aircraft manufacturing and service method 400 as shown in FIG. 4 and aircraft 500 as shown in FIG. 5. Turning first to FIG. 4, an illustration of an aircraft manufacturing and service method in a form of a block diagram is depicted in accordance with an illustrative embodiment. During pre-production, aircraft manufacturing and service method 400 may include specification and design 402 of aircraft 500 in FIG. 5 and material procurement 404.

During production, component and subassembly manufacturing 406 and system integration 408 of aircraft 500 takes place. Thereafter, aircraft 500 may go through certification and delivery 410 in order to be placed in service 412. While in service 412 by a customer, aircraft 500 is scheduled for routine maintenance and service 414, which may include modification, reconfiguration, refurbishment, or other maintenance and service.

Each of the processes of aircraft manufacturing and service method 400 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 5, an illustration of an aircraft in a form of a block diagram is depicted in which an illustrative embodiment may be implemented. In this example, aircraft 500 is produced by aircraft manufacturing and service method 400 of FIG. 4 and may include airframe 502 with plurality of systems 504 and interior 506. Examples of systems 504 include one or more of propulsion system 508, electrical system 510, hydraulic system 512, and environmental system 514. Any number of other systems may be included.

Apparatuses and methods embodied herein may be employed during at least one of the stages of aircraft manufacturing and service method 400. One or more illustrative embodiments may be manufactured or used during at least one of component and subassembly manufacturing 406, system integration 408, in service 412, or maintenance and service 414 of FIG. 4.

The illustrative examples present a coating system that protects a composite component. The coating system protects the composite component from degradation from cyclic exposure to at least one of ultraviolet light or visible light and moisture while meeting standards for solar absorptivity, color, and crack resistance. Layers are arranged in a specific order and with a specific thickness within the coating system to selectively absorb and/or reflect specific wavelengths of solar radiation while meeting the other standards for purpose.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A coating system for a composite component comprising:
a first layer comprising a chemical blocker configured to prevent transmission of at least one of ultraviolet light or visible light within desired wavelengths; and
a second layer thereover and in contact with the first layer and configured to reflect infrared components of sunlight, the second layer comprising a colorant configured to reflect the infrared components of sunlight, wherein the first layer is positioned between the second layer and the composite component.

2. The coating system of claim 1, wherein the colorant comprises titanium dioxide, and wherein the second layer further comprises a polyurethane.

3. The coating system of claim 1, wherein the second layer has a desired exterior color for performance.

4. The coating system of claim 1, wherein the second layer is white or gray.

5. The coating system of claim 1, wherein the first layer comprises a polyurethane or an epoxy, and wherein the chemical blocker comprises at least one of a benzotriazole, a triazine, or a benzophenone.

6. The coating system of claim 1, wherein the first layer further comprises a colorant having a light color.

7. The coating system of claim 1, wherein the first layer comprises a thickness between 0.3-2.4 mils.

8. The coating system of claim 1, wherein the second layer comprises a thickness between 2.0-4.0 mils.

9. The coating system of claim 1, wherein the first layer blocks transmission of at least one of ultraviolet light or visible light through absorption.

10. The coating system of claim 1, wherein the second layer provides thermal control for the coating system through controlled solar absorptivity.

11. The coating system of claim 1, wherein the second layer provides a solar absorptivity in a range of 0.20-0.67.

12. The coating system of claim 1, wherein the desired wavelengths are in a range of 300-550 nm.

13. The coating system of claim 1 further comprising:
an outer clear coat in contact with the second layer.

14. An aircraft comprising:
a composite component; and
a coating system on the composite component, the coating system comprising:
a first layer comprising a chemical blocker configured to prevent transmission of at least one of ultraviolet light or visible light within desired wavelengths, and
a second layer configured to reflect infrared components of sunlight, the second layer comprising a colorant configured to reflect the infrared components of sunlight, wherein the first layer is positioned between the second layer and the composite component.

15-19. (canceled)

20. The aircraft of claim 14, wherein the composite component is one of a fuselage, a wing, or a portion of a tail section of the aircraft.

21-22. (canceled)

23. The aircraft of claim 14, wherein the chemical blocker comprises at least one of a benzotriazole, a triazine, or a benzophenone.

24. (canceled)

25. The aircraft of claim 14, wherein the desired wavelengths are in a range of 300-550 nm.

26. (canceled)

27. The aircraft of claim 14, wherein the composite component comprises one of a thermoset resin, an epoxy resin or a thermoplastic resin.

28. (canceled)

29. The aircraft of claim 14, wherein the composite component comprises at least one of carbon fibers, boron fibers, glass fibers, polyester fibers, aramid fibers, or polymer fibers.

30-31. (canceled)

32. A coating system for a composite component comprising:
a first layer configured to prevent transmission of at least one of ultraviolet light or visible light within desired wavelengths and comprising a chemical blocker comprising at least one of a benzotriazole, a triazine, or a benzophenone; and
a second layer configured to provide a desired solar absorptivity and comprising between 16 wt %-41 wt % titanium dioxide, the second layer in contact with the first layer, wherein the first layer is positioned between the second layer and the composite component.

33-37. (canceled)
